(19) United States
(12) Patent Application Publication
(10) Pub. No.: US 2006/0107565 A1
(43) Pub. Date: May 25, 2006

(54) Display device for a cooler door

(76) Inventors: Bernard Primiano, Marietta, GA (US); James David Robertson, Atlanta, GA (US)

Correspondence Address: JOHN L. JAMES, P.O. BOX 2025, MARIETTA, GA, 30061-2025, US

(21) Appl. No.: 10/994,919

(22) Filed: Nov. 22, 2004

(51) Int. Cl. G09F 11/12

(52) U.S. Cl. 40/472

(57) ABSTRACT

A display device for mounting on an inside surface of a cooler door has a mounting bracket for attaching to the cooler door, a top tube mounted on the first mounting bracket, and a bottom tube mounted on the first mounting bracket below the top tube. A display scroll is entrained about the top and bottom tubes so that the scroll is visible through the cooler door. As the scroll is rotated about the tubes, a display graphic on the scroll moves to attract the attention of potential consumers.

### TECHNICAL FIELD OF THE INVENTION

This invention relates generally to a cooler, and, more particularly, to a display device for a transparent cooler door.

### BACKGROUND OF THE INVENTION

Upright coolers in supermarkets and convenience stores typically have transparent glass doors so that the products inside are visible. It is now common to use the inside of the door for shelving as is done in household refrigerators. Door shelving fits against the door so that the product containers are visible, however the product labels do not always face forward for easy identification of the product. Some shelves have a small area for affixing product identification, but such small areas lack the impact needed, especially for impulse purchases. Accordingly, it will be appreciated that it would be highly desirable to have a cooler door display device with a large area for product labeling and identification.

Some coolers have display panels or other advertising material affixed to the front of the cooler door where it has maximum visibility. Some panels have raised portions to further increase visibility and interest. While such front panels and raised panels are highly visible, they present static images. Static images often lack the sensory impact needed to spur impulse buying. Accordingly, it will be appreciated that it would be highly desirable to have a cooler door display device with an attention grabbing feature.

### SUMMARY OF THE INVENTION

The present invention is directed to overcoming one or more of the problems set forth above. Briefly summarized, according to one aspect of the present invention a display device for an inside surface of a cooler door comprises a frame having opposed top and bottom panels and opposed first and second side panels with the panels defining a window; a first upright member attached to the first side panel and having an inside surface and an outside surface; and a second upright member attached to the second side panel and having an inside surface facing the inside surface of the first upright member. A top tube is mounted on the first and second upright members behind the top panel of the frame. A bottom tube is mounted on the first and second upright members behind the bottom panel of the frame. A display scroll is entrained about the top and bottom tubes so that the scroll is visible through the window.

As the scroll is rotated about the tubes, a display graphic on the scroll moves to attract the attention of potential consumers. Being at the cooler door, the graphic remains visible at all times in contrast to actual product which may be located at the rear of the cooler shelf where it is difficult to recognize. A display panel can be used with a transparent scroll. The display panel attaches to the bottom tube and the scroll graphic travels in front of the display panel and behind the display panel. During breaks in the scroll graphic, the display graphic is visible.

These and other aspects, objects, features and advantages of the present invention will be more clearly understood and appreciated from a review of the following detailed description of the preferred embodiments and appended claims, and by reference to the accompanying drawings

### BRIEF DESCRIPTION OF THE DRAWINGS

FIG. 1 is a front view of a preferred embodiment of a display device attached to the inside surface of an upright cooler door according to the present invention.

FIG. 2 is a perspective front view of the display device of FIG. 1.

FIG. 3 is a perspective rear view of the display device of FIG. 1.

FIG. 4 is a diagrammatic side view of the display device of FIG. 1 with the right upright removed.

### DETAILED DESCRIPTION OF THE PREFERRED EMBODIMENTS

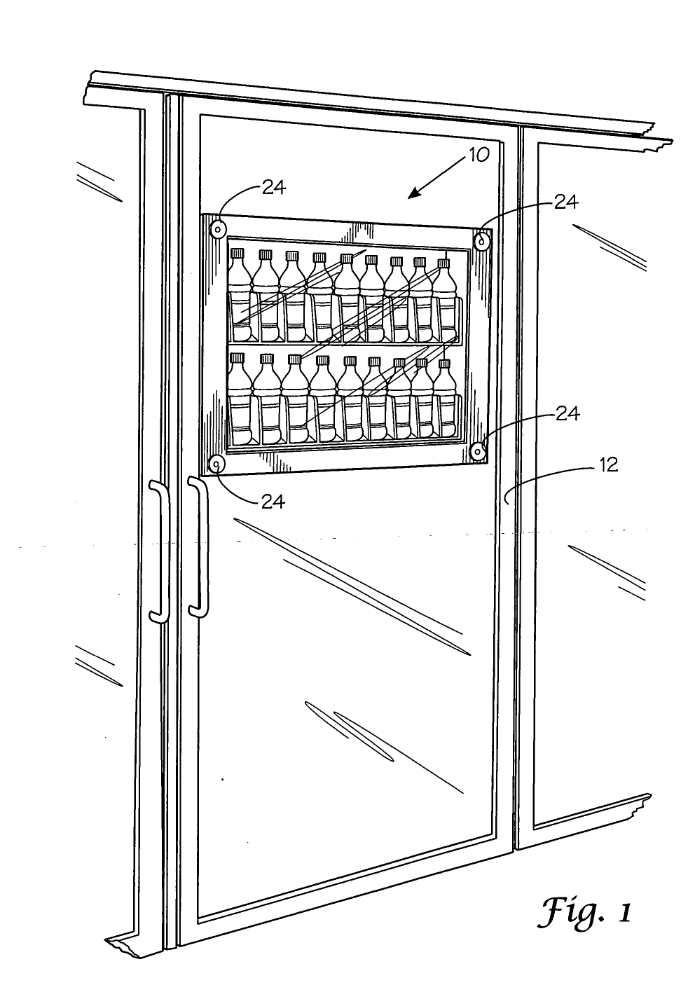

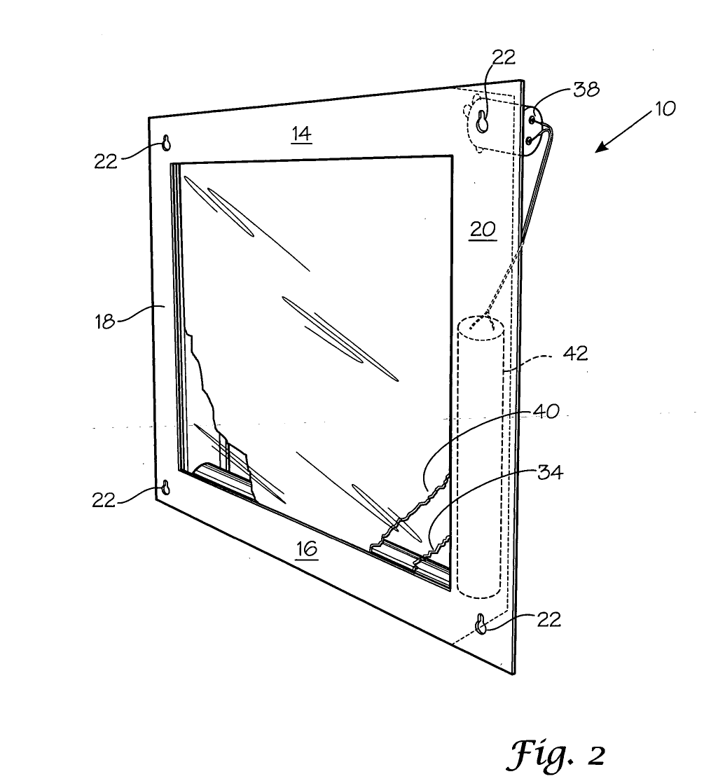

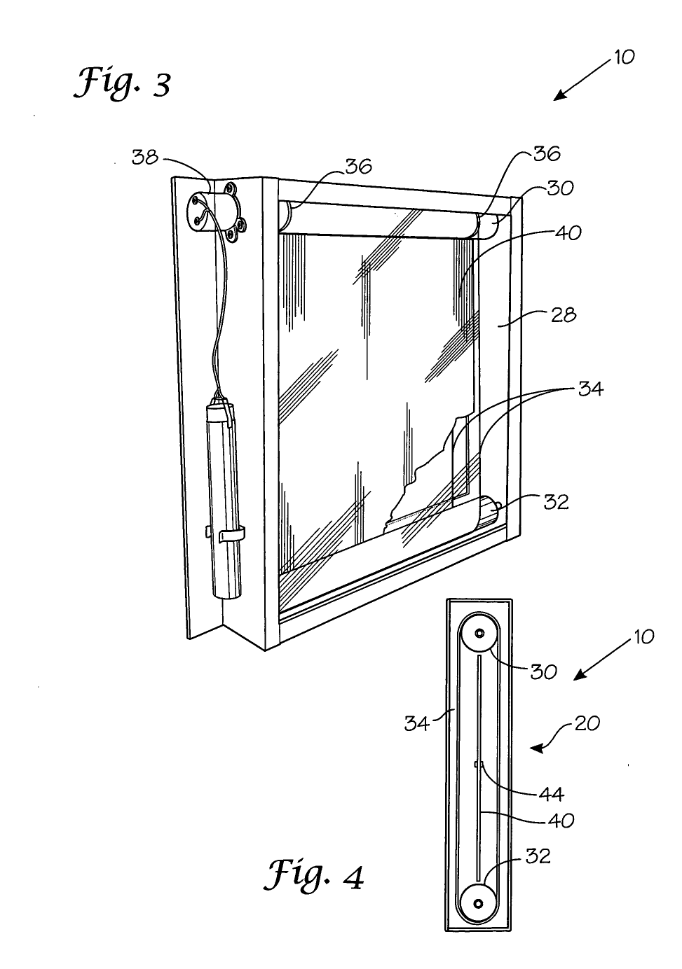

Referring to FIGS. 1-4, a display device 10 for an inside surface of a door 12 of a cooler such as those used for beverages and other refrigerated products. As illustrated, door 12 is hinged on the right and has a handle on the left for convenient opening by a right-handed consumer. Display device 10 has a frame having opposed top and bottom panels 14, 16 and opposed left and right side panels 18, 20. Panels 14, 16, 18, 20 define a window through which the graphics of the device are viewed. The frame is preferably constructed of cardboard or the like and equipped with keyways 22 in side panels 18, 20, or more preferably, in top and bottom panels 14, 16 to receive a protruding portions of suction cups 24.

A right upright member 26 is attached to right side panel 20. Upright member 26 has an inside surface facing toward the window and an outside surface facing away from the window. A left upright member 28 is attached to left side panel 18 and has an inside surface facing the inside surface of right upright member 24. Each upright member preferably has a general L-shaped cross section, and, when attached to its associated side panel, forms a C-channel structure which increases rigidity and structural integrity.

A top tube 30 is mounted on the upper portions of left and right upright members 18, 20 and extends therebetween behind the top panel 14 of the frame. A bottom tube 32 is mounted on the lower portions of left and right upright members 18, 20 and extends therebetween behind the bottom panel 16 of the frame. Bottom tube 32 has its ends mounted in longitudinal slots in the upright members and has freedom to move vertically to maintain scroll tension.

A display scroll 34 is entrained about the top and bottom tubes 30, 32 so that the scroll is visible through the window. The scroll 34 is preferably an endless piece of flexible material. To increase scroll traction, one or more rubber bands 36 may encircle top tube 30, or top tube 30 may be coated with a substance to increase friction and thereby improve traction.

A motor 38 powered by an energy pack or battery 42 and mounted on the right upright member 26 provides a means for rotating display scroll 34. Where the cooler door 12 is hinged on the left, motor 38 can be mounted on left upright member 28. As illustrated, motor 38 is attached to right upright member 26 outside the window.

A display panel 40 stands upright above bottom tube 32 and is encircled by display scroll 34. Panel 40 may be attached to one or both of the upright members 26, 28 with an adhesive or the like, or may attached with a clip 44 or the like. Optionally, panel 40 can attach to tube 40 where such tube is constructed to have a stationary portion. A graphic design may appear on panel 40 to be used in conjunction with graphics on display scroll 34. For such an application, display scroll 34 may be constructed of acetate or other transparent, flexible material so that panel 40 is visible through selected areas of the scroll graphic. It is also possible to combine the stationary graphics on panel 40 with the moving graphic on scroll 34 to form a single graphic with motion.

While the invention has been described with particular reference to the preferred embodiments, it will be understood by those skilled in the art that various changes may be made and equivalents may be substituted for elements of the preferred embodiments without departing from invention. For example, As illustrated, each upright member is a single continuous member but may be bifurcated and comprised of upper and lower brackets spaced from one another. Spaced brackets have the advantage of saving weight but the disadvantage of presenting a less finished appearance. It is accordingly intended that the claims shall cover all such modifications and applications as do not depart from the true spirit and scope of the invention.

Element List

10 display device

12 cooler door

14 top frame panel

16 bottom frame panel

18 left frame panel

20 right frame panel

22 keyways

24 suction cups

26 right upright member

28 left upright member

30 top tube

32 bottom tube

34 display scroll

36 rubber band

38 motor

40 display panel

42 motor

44 clip

What is claimed is:

1. A display device for an inside surface of a cooler door, comprising:
a frame having opposed top and bottom panels and opposed first and second side panels, said panels defining a window;
a first upright member having an inside surface and an outside surface and being attached to said first side panel;
a second upright member attached to said second side panel and having an inside surface facing said inside surface of said first upright member;
a top tube mounted on said first and second upright members behind said top panel of said frame;
a bottom tube mounted on said first and second upright members behind said bottom panel of said frame;
a display scroll entrained about said top and bottom tubes so that said scroll is visible through said window; and
means for rotating said display scroll.

2. A display device, as set forth in claim 1, wherein said means for rotating said display scroll includes a motor.

3. A display device, as set forth in claim 2, wherein said motor is mounted on said first upright member.

4. A display device, as set forth in claim 3, wherein said motor is attached to said top tube.

5. A display device, as set forth in claim 4, including at least one traction increasing device on said top tube adapted to increase traction between said scroll and said top tube.

6. A display device, as set forth in claim 1, wherein said first and second upright members each define a longitudinal slot and wherein said bottom tube is mounted in said slots.

7. A display device, as set forth in claim 1, including:
means for mounting said frame, said frame defining keyways for receiving said mounting means.

8. A display device, as set forth in claim 7, wherein said mounting means includes a suction cup.

9. A display device, as set forth in claim 1, including a display panel upstanding above said bottom tube.

10. A display device, as set forth in claim 9, wherein said display scroll encircles said display panel.

11. A display device for an inside surface of a cooler door, comprising:
a frame having opposed top and bottom panels and opposed first and second side panels, said panels defining a window;
a first upright member having an inside surface and an outside surface and being attached to said first side panel;
a second upright member attached to said second side panel and having an inside surface facing said inside surface of said first upright member;
a top tube rotatably mounted on said first and second upright members behind said top panel of said frame;
a bottom tube rotatably mounted on said first and second upright members behind said bottom panel of said frame;
a display scroll entrained about said top and bottom tubes so that said scroll is visible through said window; and
a motor attached to said first upright member outside said window and attached to one of said top and bottom tubes to thereby rotate same.

12. A display device, as set forth in claim 11, including:
means for mounting said frame, said frame defining keyways for receiving said mounting means, said mounting means including a suction cup.

13. A display device, as set forth in claim 11, including a display panel upstanding above said bottom tube.

14. A display device, as set forth in claim 13, wherein said display scroll encircles said display panel.

15. A display device, as set forth in claim 13, wherein at least one of said first and second upright members contains a clip said display panel is held by said clip.
